(19) United States
(12) Patent Application Publication
(10) Pub. No.: US 2024/0386239 A1
(43) Pub. Date: Nov. 21, 2024

(54) OUTLIER ATTENUATION IN TRANSFORMER NEURAL NETWORKS

(71) Applicant: QUALCOMM Incorporated, San Diego, CA (US)

(72) Inventors: Yelysei BONDARENKO, Amsterdam (NL); Markus NAGEL, Amsterdam (NL); Tijmen Pieter Frederik BLANKEVOORT, Amsterdam (NL)

(21) Appl. No.: 18/482,196

(22) Filed: Oct. 6, 2023

Related U.S. Application Data
(60) Provisional application No. 63/502,454, filed on May 16, 2023.

(51) Int. Cl. G06N 3/04

(52) U.S. Cl. CPC G06N 3/04

(57) ABSTRACT

Certain aspects of the present disclosure provide techniques and apparatus for processing data using a transformer neural network. The method generally includes receiving an input for processing using a transformer neural network. An attention output is generated in the transformer neural network. Generally, the attention output may be generated such that outlier values for the attention output are attenuated in the transformer neural network. An output of the transformer neural network is generated based on the generated attention output.

### CROSS-REFERENCE TO RELATED APPLICATIONS

This application claims benefit of and priority to U.S. Provisional Patent Application Ser. No. 63/502,454, entitled “Outlier Attenuation in Transformer Neural Networks,” filed May 16, 2023, and assigned to the assignee hereof, the entire contents of which are hereby incorporated by reference.

### INTRODUCTION

Aspects of the present disclosure relate to neural networks.

Various machine learning architectures have been used to provide solutions for a wide variety of computational problems. An assortment of machine learning model architectures exist, such as artificial neural networks (which may include convolutional neural networks (CNNs), recurrent neural networks (RNNs), deep neural networks, generative adversarial networks (GANs), etc.), random forest models, and the like. Increasingly, transformer neural networks are being used in a variety of image and video processing tasks, natural language processing, or other tasks in which multidimensional data is processed in order to generate various inferences related to the multidimensional data. As used herein, the term “multidimensional” generally refers to three or more dimensions (e.g., at least height, width, and time).

Neural networks, such as transformer neural networks, generally are trained based on gradient descent or other techniques that backpropagate outputs of the neural network in order to identify a set of parameters that results in a model that achieves a target level of inference performance.

### BRIEF SUMMARY

Certain aspects provide a processor-implemented method. The method generally includes receiving an input for processing using a transformer neural network. An attention output is generated in the transformer neural network. Generally, the attention output may be generated such that outlier values for the attention output are attenuated in the transformer neural network. An output of the transformer neural network is generated based on the generated attention output.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 illustrates an example transformer neural network architecture in which multidimensional data is processed.

FIG. 2 illustrates an example transformer neural network including a gated attention block that attenuates outliers in the transformer neural network, according to aspects of the present disclosure.

FIG. 3 illustrates example operations for processing data through a transformer neural network that attenuates outliers, according to aspects of the present disclosure.

FIG. 4 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for processing inputs using transformer neural networks.

Various types of neural networks can be used to process visual content (e.g., detect objects, predict future motion of objects detected in visual content, segment visual content into different semantic groups, etc.), such as still images or streams of visual content (e.g., video content captured as a series of images at a given frame rate, such as 24 frames per second, 29.97 frames per second, 60 frames per second, etc.). However, these neural networks generally process visual content on a per-frame basis, which may be a computationally expensive process that increases in complexity as the frame size of each frame in the visual content increases.

Transformer neural networks (also referred to as “transformers”), and in particular vision transformers, have become increasingly common in a wide variety of machine learning tasks. Transformer-based architectures are generally configured to generate output based on a sequence of data (e.g., a sequence of frames in a video, a sequence of patches from a frame or image, and the like). Generally, machine learning models may use any number of transformer blocks (each providing self-attention), as well as any other components (e.g., one or more neural network layers).

Transformer neural networks generally learn and classify data based on significant outliers. Because these transformer neural networks learn significant outliers, transformer neural networks generally use large and/or complex data types for data within the transformer neural networks, such as 16-bit integers, or varying sizes of floating-point numbers (e.g., 8-bit floating point, 16-bit floating point, etc.), to accommodate the large dynamic range of valid data within the transformer neural network. The generation of these significant outliers within a transformer neural network generally is a self-perpetuating event, as linear units within a neural network (e.g., softmax linear units or the like) may generate a gradient signal that causes the transformer neural network to learn to generate ever further outliers, because these linear units generally do not generate a value of 0 unless the input is a value of −∞. Because −∞ is a theoretical value which inputs into a linear unit of a neural network may approach −∞ but may not equal, linear units generally do not output a value of 0 for any input into these linear units (but output values ever closer to 0 as the input approaches −∞).

For example, in a natural language processing application, transformer neural networks may include attention heads that allocate a significant number of attention probabilities to separator tokens (e.g., non-word tokens, such as those corresponding to a space character, periods, commas, the “[SEP]” token (or other separator token) representing a delimiter between different sentences, etc.). These transformer neural networks generally learn to have small values for these separator tokens, and thus, in training, the neural network attempts to either bypass updating residual layers within the neural network or partially updates the residual layers in the neural network. To achieve attention probabilities close to zero for non-separator tokens, the inputs into linear units (e.g., a softmax linear unit) generally have a large dynamic range. Normalization techniques generally soften outliers, and thus, in order to affect the output of a neural network, outliers generally are large absolute values (e.g., relative to other statistical measures). For example, an outlier may be defined as a value that is more than a defined number of standard deviations away from the mean of an activation tensor or a value whose absolute value exceeds a threshold value. As discussed, significant outliers generally cause a neural network to learn to generate ever further outliers, which may thus increase the computational complexity involved in processing data using transformer neural networks (e.g., as these neural networks may quantize data into bins defined by large, complex data types that are computationally expensive to process).

Aspects of the present disclosure provide techniques for reducing the computational cost of processing input data in transformer neural networks. As discussed in further detail herein, to reduce the computational complexity of processing a multidimensional input, aspects of the present disclosure process data through elements of a transformer neural network that are configured to attenuate outliers within the neural network. As used herein, “attenuating outliers” generally refers to attenuating the absolute values of outliers input into an activation function (e.g., by clipping data such that outliers processed through a nonlinear activation function do not result in the generation of post-activation values that approach, but do not equal, a defined minimum or maximum value and result in the neural network learning to generate ever further outliers from input data). By attenuating outliers in a neural network, the computational expense involved in processing an input in a transformer neural network may be reduced, as the dynamic range of data in the neural network may be reduced and allow for data to be quantized using smaller and simpler data types (e.g., allowing data to be processed using 8-bit integer instead of larger integers or floating-point data). Thus, fewer compute resources may be utilized to complete various tasks for which transformer neural networks are used, such as object detection or other computer vision tasks. In turn, the techniques discussed herein may reduce the amount of power used by computing devices to perform these tasks and/or accelerate processing of multidimensional inputs, relative to the amount of power and/or time used when outliers are not attenuated in a transformer neural network.

### Example Transformer Architecture

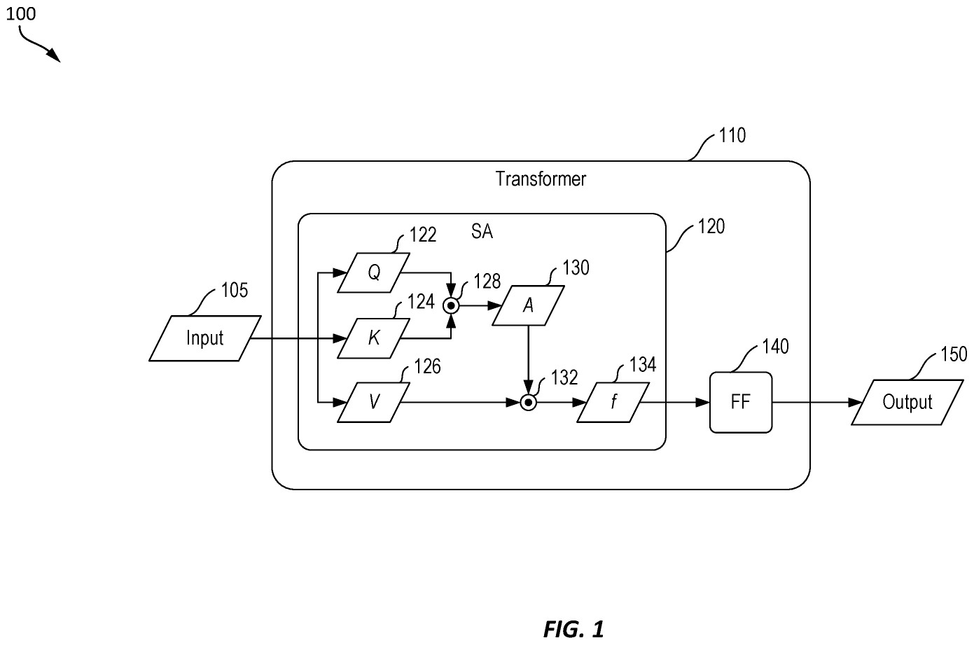

FIG. 1 illustrates an example transformer neural network 100 in which attention data is propagated through a transformer block in the neural network (e.g., for other transformer block(s) in the network) in order to generate an output of the neural network.

As illustrated in FIG. 1, input data 105 is accessed by a transformer 110 (an example of a transformer block). As used herein, accessing data can generally include receiving, retrieving, requesting, or otherwise gaining access to the data. As discussed above, the input data 105 may correspond to the input (e.g., raw or preprocessed input data) to the first transformer block of a model, the output of a prior transformer or other model component or block, and the like. For example, the input data 105 may correspond to a multidimensional input, a tokenized version of the multidimensional input (which may optionally include positional embedding(s) and/or learnable token(s)), or the like. The tokenized version of the multidimensional input may also be referred to as a set of features for the multidimensional input generated over different portions of the multidimensional input (e.g., different spatial portions, or patches, of the multidimensional input across multiple points in time).

Generally, the transformer 110 includes a self-attention block 120 (labeled “SA”) and a feedforward block 140 (labeled “FF”). In the self-attention block 120, the input data 105 may be linearly projected (e.g., multiplied using learned parameters) into three matrices: a query matrix Q 122 (also referred to in some aspects as a “query representation” or simply “queries”), a key matrix K 124 (also referred to in some aspects as a “key representation” or simply “keys”), and a value matrix V 126 (also referred to in some aspects as a “value representation” or simply “values”). For example, during training, one or more query weights, key weights, and value weights are learned based on training data, and the queries Q 122, the keys K 124, and the values V 126 can be generated by multiplying the input data by the learned weights.

In some aspects, an attention matrix A (also referred to as an “attention map” or simply “attention” in some aspects) is then generated as an output of an attention block 130 based on the queries and keys. For example, the self-attention block 120 may, at a combiner 128, compute the dot product of the query matrix and the transposed key matrix (e.g., Q·K^{T}). In some aspects, the attention block 130 can apply one or more operations (e.g., a row-wise softmax operation) to the dot product generated by the combiner 128 to yield the attention matrix A. That is, the attention matrix A generated by the attention block 130 may be defined as A=σ(Q·K^{T}), where σ corresponds to a regularizing function usable in a transformer neural network, such as a softmax function or the like.

The resulting features f 134 generated by the self-attention block 120 can then be computed, at the combiner 132, as the dot product of the attention matrix A generated by the attention block 130 and the value matrix V 126. These features f 134 can then be provided as an input to the feedforward block 140 (e.g., a neural network or subnet) to generate an output 150 from the transformer 110. The output 150 may be used as an input into a subsequent transformer or other block in the neural network or may be the final result of processing an input through the neural network. The feedforward block 140, in some aspects, may be a multilayer perceptron (MLP) including a plurality of layers separated by an activation function, such as a Gaussian error linear unit activation function.

Although not depicted in FIG. 1, in some aspects, the transformer 110 may include one or more skip or residual connections (with or without layer normalization). For example, the output 150 may be generated by summing the output of the combiner 132 with the input data 105, skipping the feedforward block 140. As another example, the output 150 of the transformer 110 may be generated by summing the output of the final layer of the feedforward block 140 with the previous version of the output 150.

### Example Outlier Attenuation in Transformer Neural Networks

As discussed, transformer neural networks can be used to process multidimensional inputs and generate inferences based on processing these multidimensional inputs. For example, these transformer neural networks can be used in performing various operations on video data, such as video enhancement (e.g., noise reduction, upsizing via super resolution techniques that increase or otherwise enhance the resolution of an input), object detection, three-dimensional vision, medical imaging, natural language processing, or the like.

In object detection tasks, for example, the outputs generated by transformer neural networks can be used to semantically segment an input into different segments associated with different levels of importance to the overall meaning of the scene and select different portions of the scene for monitoring (e.g., corresponding to different objects). The outputs generated by transformer neural networks can also be used, for example, to predict the motion of objects in a scene, which then can be used to apply various control inputs to an autonomous or semi-autonomous vehicle to ensure that the vehicle does not collide with these objects (or at least reduce the likelihood that the vehicle will collide with these objects).

In three-dimensional vision examples, transformer neural networks can be used to recreate environments in the three-dimensional space based on truncated signed distance function (TSDF) data or the like. In medical imaging examples, transformer neural networks can be used for segmentation of three-dimensional data to identify various structures in captured medical imaging, such as blood vessels, tumors, and the like. In natural language processing examples, bidirectional transformers can be used to identify context and meaning in a text string and learn to predict text following the input string.

To reduce the complexity involved in processing data in transformer neural networks, aspects of the present disclosure provide techniques that attenuate the magnitude of outliers within the attention block of a transformer neural network. By attenuating the magnitude of outliers in the transformer neural network, aspects of the present disclosure may allow for data to be quantized into smaller and simpler data types which may use fewer computational resources for processing.

As discussed, linear units and/or other activation functions in a neural network, such as the transformer neural network 100 illustrated in FIG. 1, generally generate outputs between 0 and 1 based on the value of the input into these linear units and/or other activation functions. Many of these linear units and/or activation functions may not generate an output that equals one of these values; for example, some linear units and/or other activation functions may output a value of 1 when the value of the input is equal to the theoretical value of ∞ and may output a value of 0 when the input is equal to the theoretical value of −∞. Because neural networks generate outliers in a self-perpetuating matter, the inability of many linear units or other activation functions to generate a value of 0 for valid, non-theoretical input values, causes the transformer neural network to learn to generate ever further outliers, which in turn increases the computational complexity involved in processing data using transformer neural networks.

To attenuate outliers in a neural network, and thus to reduce the computational complexity involved in processing data using neural networks (e.g., a transformer neural network), a clipped linear unit may be used in the attention block 130 to generate the output of the attention block 130, as discussed in further detail herein.

Generally, the attention output generated by a non-clipped linear unit in the attention block 130 of the self-attention block 120 in the transformer neural network 100 may be represented by the expression:

$$Attention ( Q , K , V ) := softmax ( \frac{Q {K}^{T}}{\sqrt{d}} ) V$$

where Q represents a query matrix, K^{T} represents a transposed key matrix, V represents a value matrix, and d represents a dimensionality of the inputs into the attention block 130.

As discussed, a softmax function, or other linearizing activation function with similar properties, may be configured to generate values between 0 and 1 for any given input into the softmax function. However, a softmax function generally is not configured to output either a value of 0 or a value of 1. Rather, the softmax function generally outputs values that approach 0 as inputs approach −∞ and generally outputs values that approach 1 as inputs approach ∞. Because the softmax function does not output a value of 0 or a value of 1, as discussed, the softmax function may generate signals (e.g., output values) that cause a neural network to continue to search for minima or maxima and thus cause a neural network to operate based on ever larger absolute values and ever larger dynamic ranges of data.

To reduce the computational complexity involved in processing data in a neural network, a clipped softmax function may be defined with hyperparameters ξ and γ (also referred to herein as “clipping thresholds”) that modify the output of the softmax function. The clipped softmax function may be represented by the expression:

$$clipped\_softmax ( x ; ζ , γ ) := clip ( ( ζ - γ ) \cdot softmax ( x ) + γ , 0 , 1 )$$

where x represents an input into the clipped softmax function, clip( ) represents a function that outputs a value of 0 for inputs smaller than 0 and outputs a value of 1 for inputs larger than 1, ξ≥1, and γ≤0.

Within the clipped softmax function, different values for ξ and γ generally affect the output of the softmax function. When ξ>1, the clipped softmax function may be configured to output values up to and including 1. Meanwhile, when γ<0, the clipped softmax function may be configured to output values down to and including 0. Thus, the clipped softmax function may allow for the output of values that can halt, or at least reduce the likelihood of, the transformer neural network continuing to search for a minima or maxima (e.g., via gradient descent or ascent) based on ever further outliers generated in the neural network.

In some aspects, the clipping thresholds ξ and γ may be related to the sequence length T of an input into the neural network and to a hyperparameter α that describes the average value of the attention weight. For example, the clipping threshold γ may be set based on the

$$expression - \frac{α}{T} .$$

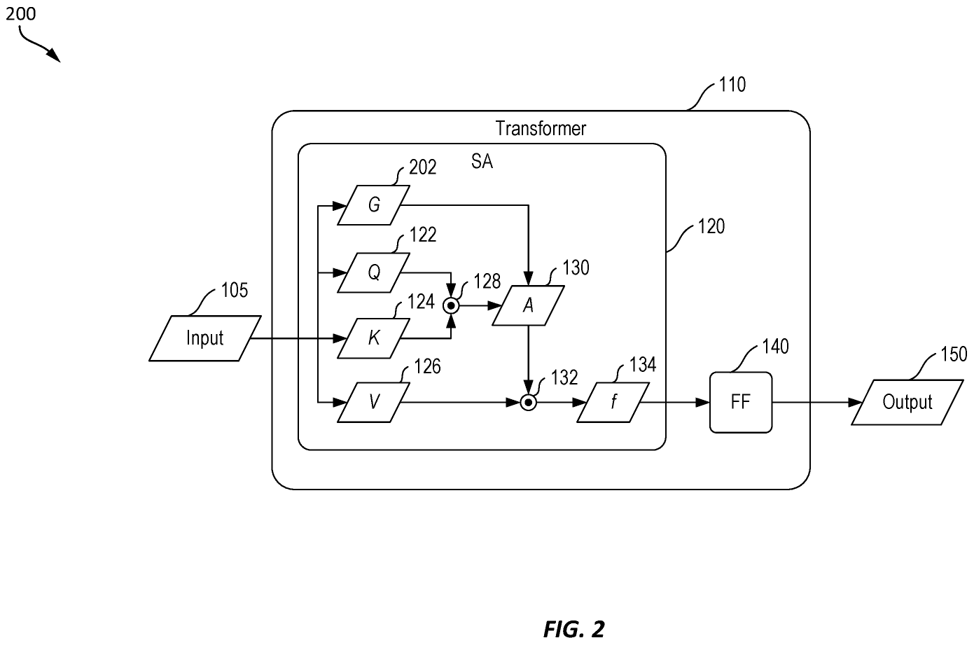

FIG. 2 illustrates an example transformer neural network 200 including a gated attention block (also referred to as a “gate block”) that attenuates the magnitude of outliers in the transformer neural network, according to aspects of the present disclosure. As illustrated, the transformer neural network 200 adds a gate block 202 to the transformer neural network 100 illustrated in FIG. 1. Generally, the gate block 202 allows the self-attention block 120 to represent values down to and including 0 to reduce the likelihood that the transformer neural network 200 will learn to generate ever further outliers that increases the computational complexity of processing data through the transformer neural network 200.

An attention output (or matrix) A in the self-attention block 120, for a given input x having dimensions of B, corresponding to the batch size, T, corresponding to the sequence length, and d_{model}, corresponding to the number of embeddings (or features or channels), may be represented by the expression:

A(x):=\hat{P}(x)V(x)

where \hat{P}(x) represents the gated output of a softmax (or other linear) function and V(x) represents a value matrix associated with input x. Input x may be, for example, a sequence of tokens in a transformer neural network (e.g., associated with a word in a natural language input).

The gated output of the softmax (or other linear) function within the self-attention block 120, resulting in the generation of the attention matrix A by the attention block 130, may be represented by the expression:

$$\hat{P} ( x ) := sigmoid ( G ( x ) ) \cdot softmax ( \frac{Q ( x ) {K ( x )}^{T}}{\sqrt{d}} )$$

In this example, the output of the softmax function, which as discussed may be a value between 0 and 1 (but may not be exactly 0 or 1), may be multiplied by the output of a nonlinear function, such as a sigmoid function, which may output a value between 0 and 1, inclusive. The sigmoid function may generate an output based on one or more gating parameters G generated by the gate block 202 and applied to the input x. The gating parameters G may, for example, define a function to be applied to a a number of features in input x, according to a decomposition of the features of input x into n_{heads} groups with d_{head} features in each group. Examples of a gating parameter G generated by the gate block 202 may include, without limitation, a linear per-head gating function that applies a linear function separately for each of the n_{heads} groups of input features, a multilayer perceptron (MLP) applied separately for each of the n_{heads} groups of input features, linear mixing between the n_{heads} groups of input features, or the like. When, however, G(x)=0, the output of the self-attention block 120 may be 0, as the gated output of the linear function within the self-attention block 120 may equal 0, and the product of 0 and any other value may also equal 0. In some aspects, the gate block 202 receives the input data 105 as an input, and the attention block 130 receives the output of the gate block 202 as another input.

By attenuating outliers in a transformer neural network, aspects of the present disclosure may provide for increased inference performance relative to a transformer neural network without such attenuation. These increases in inference performance may apply across different data types, with aspects of the present disclosure providing larger increases in inference performance as the data type into which data is quantized in the neural network decreases in size. For example, the outlier attenuation techniques described herein may result in: (i) significant increases in perplexity metrics measuring the quality of natural language processing operations performed using a transformer neural network and (ii) quantization into small data types, such as 8-bit integers. Similar increases in inference accuracy may be seen in other applications in which transformer neural networks are used, such as in image analysis using vision transformer neural networks.

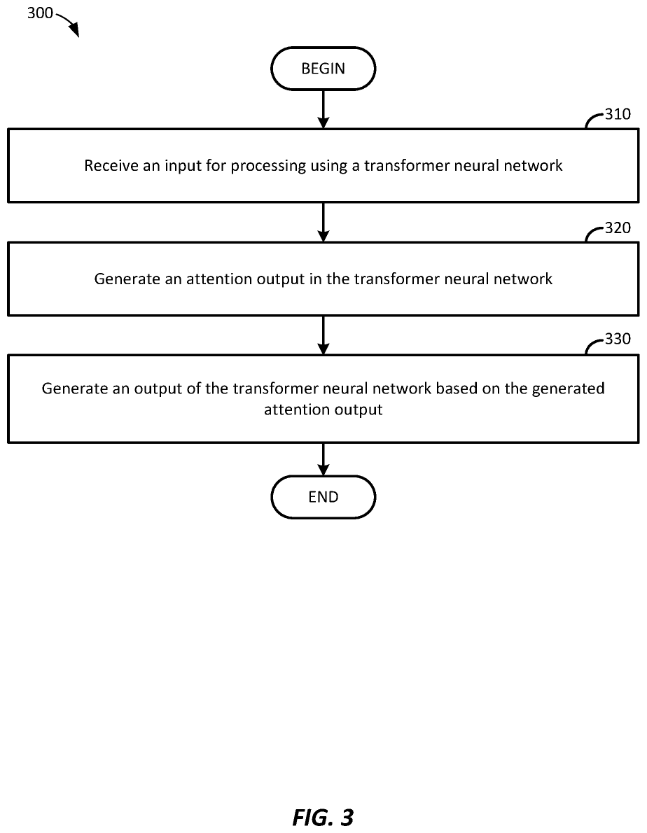

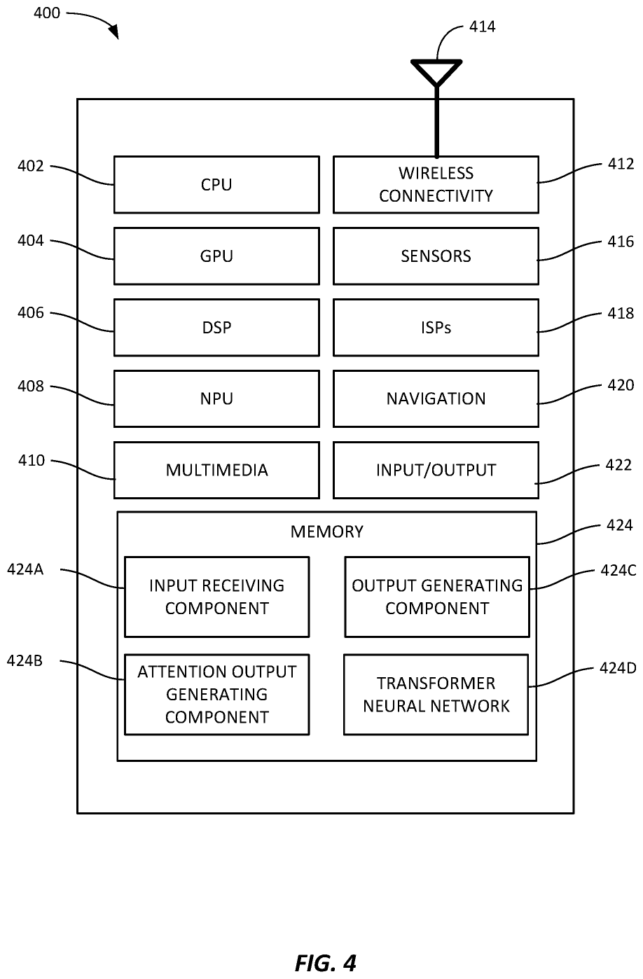

FIG. 3 illustrates example operations 300 for processing data using neural networks configured to attenuate outliers in the neural network, according to aspects of the present disclosure. The operations 300 may be performed, for example, by a computing system on which a transformer neural network (e.g., the transformer neural network 100 or 200) is deployed for processing multidimensional data, such as a user equipment (UE), a smartphone, a tablet computer, an autonomous vehicle, an edge device, or other computing system (e.g., such as processing system 400 illustrated in FIG. 4 and described in further detail below).

As illustrated, the operations 300 begin at block 310, with receiving an input for processing using a transformer neural network.

At block 320, the operations 300 proceed with generating an attention output in the transformer neural network. Generally, the attention output may be generated such that outlier values for the attention output are attenuated in the transformer neural network such that the outputs are restricted (e.g., to a defined minimum and/or maximum value for values of an input that are below a threshold value or above a threshold value).

In some aspects, generating the attention output in the transformer neural network at block 320 comprises generating the attention output based on a clipped softmax function having a dynamic range controlled by a first hyperparameter and a second hyperparameter. Generally, the first hyperparameter comprises a hyperparameter greater than or equal to 1. In this case, the second hyperparameter may comprise a hyperparameter less than or equal to 0. When the first hyperparameter is greater than 1, the clipped softmax function may output values up to and including a value of 1. When the second hyperparameter is less than 0, the clipped softmax function may output values down to and including a value of 0. By using a clipped softmax function with a value of the second hyperparameter that is less than 0, outlier values close to 0 may result in the attention output being 0 to minimize, or at least reduce, the likelihood of the transformer neural network learning ever further outliers (e.g., learning values that get progressively closer to 0 without reaching 0, since a conventional softmax function outputs the value 0 for the theoretical value of −∞). Similarly, using a clipped softmax function with a value of the first hyperparameter greater than 1 may also minimize, or at least reduce, the likelihood of the transformer neural network learning ever further outliers for data for which the attention value approaches, but does not reach, 1.

In some aspects, generating the attention output in the transformer neural network at block 320 comprises generating the attention output based on a gated attention block (e.g., gate block 202) configured to output a minimum value of 0. The gated attention block may, for example, apply a bounded nonlinear function to one or more gating parameters defined for the transformer neural network. The bounded nonlinear function may be, for example, a sigmoid function or other nonlinear function having a defined maximum value and a defined minimum value which may be output by the function. The gated attention block may be applied for each token generated by the transformer neural network for the received input.

At block 330, the operations 300 proceed with generating an output of the transformer neural network based on the generated attention output.

### Example Processing System for Processing Data in Transformer Neural Networks that Attenuate Outlier Magnitude

FIG. 4 depicts an example processing system 400 configured to perform various aspects of the present disclosure, including, for example, the techniques and methods described with respect to FIGS. 1-3. In some aspects, the processing system 400 may train, implement, or provide a machine learning model using transformer-based architectures, such as the transformer neural network 100 of FIG. 1 or the transformer neural network 200 of FIG. 2. Although depicted as a single system for conceptual clarity, in at least some aspects, as discussed above, the operations described below with respect to the processing system 400 may be distributed across any number of devices.

The processing system 400 includes a central processing unit (CPU) 402, which in some examples may be a multi-core CPU. Instructions executed at the CPU 402 may be loaded, for example, from a program memory associated with the CPU 402 or may be loaded from a partition of memory 424.

The processing system 400 also includes additional processing components tailored to specific functions, such as a graphics processing unit (GPU) 404, a digital signal processor (DSP) 406, a neural processing unit (NPU) 408, a multimedia processing unit 410, and a wireless connectivity component 412.

An NPU, such as NPU 408, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 408, are configured to accelerate the performance of common machine learning tasks, such as image classification, machine translation, object detection, and various other predictive models. In some examples, a plurality of NPUs may be instantiated on a single chip, such as a system-on-a-chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In some implementations, the NPU 408 is a part of one or more of the CPU 402, the GPU 404, and/or the DSP 406.

In some examples, the wireless connectivity component 412 may include subcomponents, for example, for third generation (3G) connectivity, fourth generation (4G) connectivity (e.g., 4G Long-Term Evolution (LTE)), fifth generation (5G) connectivity (e.g., New Radio (NR)), Wi-Fi connectivity, Bluetooth connectivity, and other wireless transmission standards. The wireless connectivity component 412 is further coupled to one or more antennas 414.

The processing system 400 may also include one or more sensor processing units 416 associated with any manner of sensor, one or more image signal processors (ISPs) 418 associated with any manner of image sensor, and/or a navigation component 420, which may include satellite-based positioning system components (e.g., GPS or GLONASS) as well as inertial positioning system components.

The processing system 400 may also include one or more input and/or output devices 422, such as screens, touch-sensitive surfaces (including touch-sensitive displays), physical buttons, speakers, microphones, and the like.

In some examples, one or more of the processors of the processing system 400 may be based on an ARM or RISC-V instruction set.

The processing system 400 also includes the memory 424, which is representative of one or more static and/or dynamic memories, such as a dynamic random access memory, a flash-based static memory, and the like. In this example, the memory 424 includes computer-executable components, which may be executed by one or more of the aforementioned processors of the processing system 400.

In particular, in this example, the memory 424 includes an input receiving component 424A, an attention output generating component 424B, an output generating component 424C, and a transformer neural network 424D. Though depicted as discrete components for conceptual clarity in FIG. 4, the illustrated components (and others not depicted) may be collectively or individually implemented in various aspects.

Generally, the processing system 400 and/or components thereof may be configured to perform the methods described herein.

Notably, in other aspects, aspects of the processing system 400 may be omitted, such as where the processing system 400 is a server computer or the like. For example, the multimedia processing unit 410, the wireless connectivity component 412, the sensor processing units 416, the ISPs 418, and/or the navigation component 420 may be omitted in other aspects. Further, aspects of the processing system 400 may be distributed between multiple devices.

### Example Clauses

Implementation details of various aspects of the present disclosure are described in the following numbered clauses:

Clause 1: A processor-implemented method, comprising: receiving an input for processing using a transformer neural network; generating an attention output in the transformer neural network, the attention output being generated such that outlier values for the attention output are attenuated in the transformer neural network; and generating an output of the transformer neural network based on the generated attention output.

Clause 2: The method of Clause 1, wherein generating the attention output in the transformer neural network comprises generating the attention output based on a clipped softmax function having a dynamic range controlled by a first hyperparameter and a second hyperparameter.

Clause 3: The method of Clause 2, wherein the first hyperparameter comprises a hyperparameter greater than or equal to 1 and wherein the second hyperparameter comprises a hyperparameter less than or equal to 0.

Clause 4: The method of Clause 3, wherein the clipped softmax function is configured to output values up to and including a value of 1 when a value of the first hyperparameter is greater than 1.

Clause 5: The method of Clause 3 or 4, wherein the clipped softmax function is configured to output values down to and including a value of 0 when a value of the second hyperparameter is less than 0.

Clause 6: The method of any of Clauses 1 through 5, wherein generating the attention output in the transformer neural network comprises generating the attention output based on a gated attention block configured to output a minimum value of 0.

Clause 7: The method of Clause 6, wherein the gated attention block applies a bounded nonlinear function to one or more gating parameters defined for the transformer neural network.

Clause 8: The method of Clause 7, wherein the bounded nonlinear function comprises a sigmoid function.

Clause 9: The method of any of Clauses 6 through 8, wherein the gated attention block is applied for each token generated by the transformer neural network for the received input.

Clause 10: A processing system comprising: a memory comprising computer-executable instructions; and one or more processors configured to execute the computer-executable instructions and cause the processing system to perform a method in accordance with any of Clauses 1-9.

Clause 11: A processing system comprising means for performing a method in accordance with any of Clauses 1-9.

Clause 12: A non-transitory computer-readable medium comprising computer-executable instructions that, when executed by one or more processors of a processing system, cause the processing system to perform a method in accordance with any of Clauses 1-9.

Clause 13: A computer program product embodied on a computer-readable storage medium comprising code for performing a method in accordance with any of Clauses 1-9.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
at least one memory having executable instructions stored thereon; and
one or more processors configured to execute the executable instructions in order to cause the processing system to:
receive an input for processing using a transformer neural network;
generate an attention output in the transformer neural network, the attention output being generated such that outlier values for the attention output are attenuated in the transformer neural network; and
generate an output of the transformer neural network based on the generated attention output.

2. The processing system of claim 1, wherein to generate the attention output in the transformer neural network, the one or more processors are configured to cause the processing system to generate the attention output based on a clipped softmax function having a dynamic range controlled by a first hyperparameter and a second hyperparameter.

3. The processing system of claim 2, wherein the first hyperparameter comprises a hyperparameter greater than or equal to 1 and wherein the second hyperparameter comprises a hyperparameter less than or equal to 0.

4. The processing system of claim 3, wherein the clipped softmax function is configured to output values up to and including a value of 1 when a value of the first hyperparameter is greater than 1.

5. The processing system of claim 3, wherein the clipped softmax function is configured to output values down to and including a value of 0 when a value of the second hyperparameter is less than 0.

6. The processing system of claim 1, wherein to generate the attention output in the transformer neural network, the one or more processors are configured to cause the processing system to generate the attention output based on a gated attention block configured to output a minimum value of 0.

7. The processing system of claim 6, wherein the gated attention block applies a bounded nonlinear function to one or more gating parameters defined for the transformer neural network.

8. The processing system of claim 7, wherein the bounded nonlinear function comprises a sigmoid function.

9. The processing system of claim 6, wherein the gated attention block is applied for each token generated by the transformer neural network for the received input.

10. A processor-implemented method, comprising:
receiving an input for processing using a transformer neural network;
generating an attention output in the transformer neural network, the attention output being generated such that outlier values for the attention output are attenuated in the transformer neural network; and
generating an output of the transformer neural network based on the generated attention output.

11. The method of claim 10, wherein generating the attention output in the transformer neural network comprises generating the attention output based on a clipped softmax function having a dynamic range controlled by a first hyperparameter and a second hyperparameter.

12. The method of claim 11, wherein the first hyperparameter comprises a hyperparameter greater than or equal to 1 and wherein the second hyperparameter comprises a hyperparameter less than or equal to 0.

13. The method of claim 12, wherein the clipped softmax function is configured to output values up to and including a value of 1 when a value of the first hyperparameter is greater than 1.

14. The method of claim 12, wherein the clipped softmax function is configured to output values down to and including a value of 0 when a value of the second hyperparameter is less than 0.

15. The method of claim 10, wherein generating the attention output in the transformer neural network comprises generating the attention output based on a gated attention block configured to output a minimum value of 0.

16. The method of claim 15, wherein the gated attention block applies a bounded nonlinear function to one or more gating parameters defined for the transformer neural network.

17. The method of claim 16, wherein the bounded nonlinear function comprises a sigmoid function.

18. The method of claim 15, wherein the gated attention block is applied for each token generated by the transformer neural network for the received input.

19. A processing system, comprising:
means for receiving an input for processing using a transformer neural network;
means for generating an attention output in the transformer neural network, the attention output being generated such that outlier values for the attention output are attenuated in the transformer neural network; and
means for generating an output of the transformer neural network based on the generated attention output.

20. The processing system of claim 19, wherein the means for generating the attention output in the transformer neural network comprises means for generating the attention output based on a clipped softmax function having a dynamic range controlled by a first hyperparameter and a second hyperparameter.

21. The processing system of claim 20, wherein the first hyperparameter comprises a hyperparameter greater than or equal to 1 and wherein the second hyperparameter comprises a hyperparameter less than or equal to 0.

22. The processing system of claim 21, wherein the clipped softmax function is configured to output values up to and including a value of 1 when a value of the first hyperparameter is greater than 1.

23. The processing system of claim 21, wherein the clipped softmax function is configured to output values down to and including a value of 0 when a value of the second hyperparameter is less than 0.

24. The processing system of claim 19, wherein the means for generating the attention output in the transformer neural network comprises means for generating the attention output based on a gated attention block configured to output a minimum value of 0.

25. The processing system of claim 24, wherein the gated attention block applies a bounded nonlinear function to one or more gating parameters defined for the transformer neural network.

26. The processing system of claim 25, wherein the bounded nonlinear function comprises a sigmoid function.

27. The processing system of claim 24, wherein the gated attention block is applied for each token generated by the transformer neural network for the received input.

28. A non-transitory computer-readable medium having executable instructions stored thereon which, when executed by one or more processors, cause the one or more processors to perform an operation comprising:
receiving an input for processing using a transformer neural network;
generating an attention output in the transformer neural network, the attention output being generated such that outlier values for the attention output are attenuated in the transformer neural network; and
generating an output of the transformer neural network based on the generated attention output.
